(19) United States
(12) Patent Application Publication
(10) Pub. No.: US 2008/0152450 A1
(43) Pub. Date: Jun. 26, 2008

(54) ROUTER

(76) Inventors: Adolf Zaiser, Koengen (DE); Heiko Roehm, Stuttgart (DE); Jens Blum, Filderstadt (DE)

Correspondence Address: Striker, Striker & Stenby, 103 East Neck Road, Huntington, NY, 11743, US

(21) Appl. No.: 11/954,710

(22) Filed: Dec. 12, 2007

(30) Foreign Application Priority Data
Dec. 22, 2006 (DE) 102006061239.6

(51) Int. Cl. B23C 1/20; B27C 5/10

(52) U.S. Cl. 409/182; 144/136.95; 409/210

(57) ABSTRACT

A router has a housing, which is displaceably accommodated between a starting position and an end position for adjustment relative to a base plate, and a device for displaying the position of the housing.

### CROSS-REFERENCE TO A RELATED APPLICATION

The invention described and claimed hereinbelow is also described in German Patent Application DE 102006061239.6 filed on Dec. 22, 2006. This German Patent Application, whose subject matter is incorporated here by reference, provides the basis for a claim of priority of invention under 35 U.S.C. 119(a)-(d).

### BACKGROUND OF THE INVENTION

The present invention is directed to a router.

A generic router is made known in DE 41 39 759 A1. The router includes a housing, from the underside of which a tool fitting for a milling tool connected with a drive extends. The housing is displaceably accommodated on two guide columns. To adjust the milling depth, the housing is displaceable between a starting position and an end position relative to a base plate, the housing including a first stop, which interacts with a second stop on the base plate.

### SUMMARY OF THE INVENTION

Accordingly, it is an object of the present invention to provide a router which is a further improvement of the existing routers.

The present invention is directed to a router with a housing, which is displaceably accommodated between a starting position and an end position for adjustment relative to a base plate.

It is provided that a device is provided for displaying the position of the housing. A design of this type results in simplified handling of the router in that the position of the housing and, therefore, the remaining displacement of the router, may be read at any time. “Remaining displacement” refers to the distance of the housing from the end position. As a result, as early as when the tool is being adjusted before milling is performed, it may be determined whether the amount of displacement remaining is sufficient for the desired milling depth.

In a further embodiment it is provided that the device for displaying the position of the housing includes a pointer that interacts with a scale, by way of which the device has a particularly simple design and may therefore be manufactured in a cost-favorable manner. The design makes it easy for the position display to be read.

It is also provided that the pointer is fixedly connected with one of the guide columns, and the scale is provided on the housing. This design makes it possible to conveniently read the position display on the housing. In addition, existing routers may be easily retrofitted by forming a slot in an existing housing and installing the pointer on one of the guide columns.

It is provided that the pointer is located at a zero point on the scale when the housing is in an end position. In the end position, the stop of the housing and the stop of the base plate lie one on top of the other. As a result, the distance of the housing from the end position, i.e., the “remaining displacement”, may be read at any time.

It is also provided that the scale extends on the housing in the direction of the vertical axis of the router, and that the zero point of the scale is located on a top end of the scale. If the two stops now move apart from each other, the pointer moves along the scale, thereby indicating the distance between the stops and the remaining displacement of the router.

Further advantages result from the description of the drawing, below. An exemplary embodiment of the present invention with additional details is shown in greater detail below, in the two figures. The figures, the description and the claims contain numerous features in combination. One skilled in the art will also advantageously consider the features individually and combine them to form further reasonable combinations.

### BRIEF DESCRIPTION OF THE DRAWINGS

FIG. 1 shows a view of an inventive router as a partial sectional view, with a housing that includes a first stop, and a base plate that includes a second stop, and a device for making rough adjustments of the milling depth, and

FIG. 2 shows a view of an inventive router as a partial sectional view, with a device for making fine adjustments of the milling depth, and with an inventive device for displaying the position of the housing.

### DESCRIPTION OF THE PREFERRED EMBODIMENTS

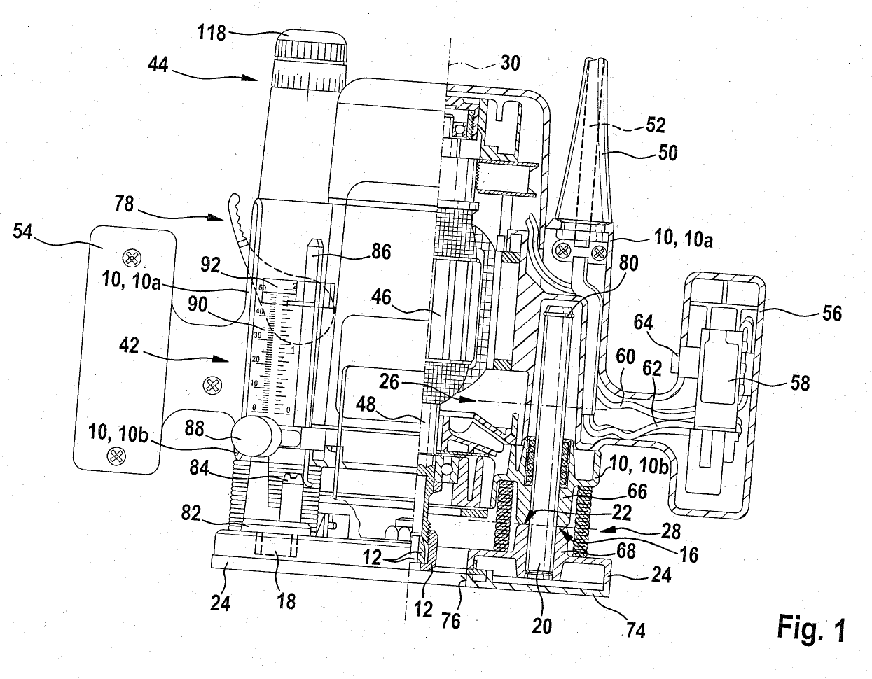

FIG. 1 shows a schematic depiction of an inventive router with a housing 10, which includes an upper part 10a, which is preferably made of plastic, and a lower part 10b, which is preferably made of aluminum. Other embodiments of housing 10, e.g., with a removable cover, are also feasible. Housing 10 is displaceably accommodated between a starting position 26 and an end position 28 for adjustment relative to a base plate 24.

A drive motor 46, which starts a motor spindle 48 rotating, is located in housing 10. Motor spindle 48 is non-rotatably connected with a tool fitting 12, which extends out of an underside of housing 10 and in which a not-shown milling tool for machining a work piece is clampable. Drive motor 46 is connected with a power connection cord 52, which extends through a protective grommet 50 and out of housing 10, and which may represent the connection to a not-shown voltage source.

Housing 10 includes at least one handle 54, 56, which is fixedly connected with housing 10. In the present exemplary embodiment, the router includes two handles 54 and 56, which are diametrically opposed to each other. Handles 54, 56 are preferably integrally moulded with upper piece 10a.

An electrical switch 58 for connecting drive motor 46 to the voltage source and for separating drive motor 46 from the voltage source is provided in one of the two handles 56, i.e., an on/off switch for drive motor 46 is provided. Switch 58 is connected via lines 60, 62 with drive motor 46 and power connection cord 52. Switch 58 for starting drive motor 46 is located inside handle 56 and includes a pushbutton 64, which is located on the outside of handle 56 and is operatively connected with switch 58. When pushbutton 64 is depressed, switch 58 and power connection cord 52 connected to the voltage source establish the electrical connection between drive motor 46 and the voltage source in the typical manner. Pushbutton 64 is located on a side of handle 56 facing the router, so that a user of the router can operate pushbutton 64 comfortably with his thumb when he grips handle 56.

First guide tubes 66, which extend essentially parallel to a vertical axis 30 of the router and a vertical axis 30 of the milling tool, are integrally moulded with lower piece 10b of housing 10. First guide tubes 66 line up directly with second guide tubes 68, which are also oriented essentially parallel to a vertical axis 30 of the router and to is vertical axis 30 of the milling tool, and which are integrally moulded with base plate 24.

First guide tubes 66 of housing 10 also serve as a first stop 16, and second guide tubes 68 of base plate 24 also serve as a second stop 22.

Base plate 24 includes a lower piece 74—which is preferably composed of plastic—for protecting the work piece to be machined. Base plate 24 and lower piece 74 have a central opening 76, into which motor spindle 48 of drive motor 46 located in housing 10 extends at least partially.

Two guide columns 18, 20 of a guide unit are guided and supported in first and second guide tubes 66, 68. A first guide column 18, as the main column, is hollow in design, and a second guide column 20 is solid in design. To adjust the milling depth, housing 10, which includes first stop 16, is accommodated on guide columns 18, 20 such that it is displaceable relative to base plate 24, which includes second stop 22, and essentially parallel to vertical axis 30 of the milling tool and in the direction of vertical axis 30 of the router. Housing 10 is accommodated such that it is displaceable between a starting position 26 with stops 16, 22 with maximum separation, and an end position 28 with stops 16, 22 lying one on top of the other, via intermediate positions and in the reverse direction.

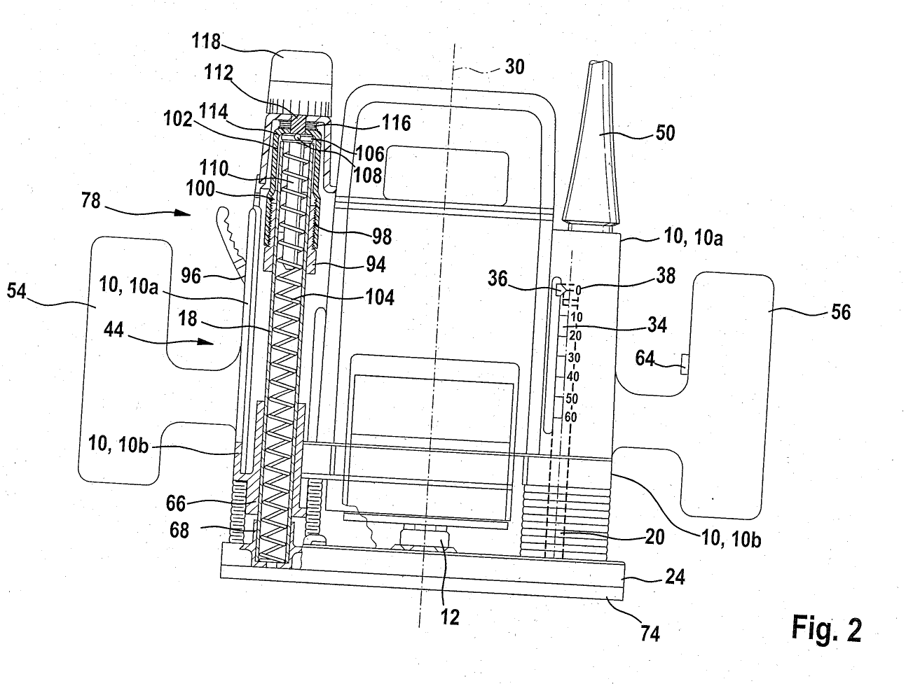

Housing 10 is detachably fixable relative to at least one of the guide columns 18, 20 using a clamping device 78, which is not shown in FIG. 2. Clamping device 78 is a component of a device 42 for adjusting a milling depth. A snap ring 80 is located in an annular groove on an upper end of solid guide column 20 facing upper piece 10a; it prevents housing 10 from accidentally sliding off of guide columns 18, 20. Solid guide column 20 prevents housing 10 from rotating, and serves to limit the upper extent of the reciprocating motion.

Device 42 for adjusting the milling depth includes a rotary plate 82 installed on base plate 24 with at least three adjustable adjusting screws 84, which serve as a stop for a rod 86 for adjusting the milling depth and which may be fixed in position using clamping unit 78, which is shown in greater detail in FIG. 2. Rod 86 is fixed in position using a fixing screw 88, which has been inserted in a screw thread in lower piece 10b of housing 10. To adjust the desired milling depth more easily, an adjustment scale 90 is provided on housing upper piece 10a, and a displaceable sliding element 92—which is preferably made of Plexiglas—with a marking line is mounted on rod 86.

As shown in FIG. 2, housing 10 is capable of being fixed in position relative to base plate 24 via clamping device 78—which is displaceably guided on main column 18 and is designed as a clamping sleeve 94—using a clamping screw 96. Clamping screw 96 is seated in a not-shown thread of clamping sleeve 94—which extends nearly at a right angle to the axis of main column 18—such that it is capable of being pressed against clamping sleeve 94.

The milling depth of the router is adjusted as usual, using rod 86 and rotary plate 82, as shown in FIG. 1. In practical application, it often becomes apparent that the milling depth was adjusted too low or too flat by a small amount, e.g., fractions of millimeters. Since it is not possible to make such a small correction via the rough adjusting using rod 86, a device 44 for making fine adjustments is also provided. The necessary correction may be attained by using device 44 for making fine adjustments with the milling tool inserted in the work piece, without changing the rough setting of the milling depth.

To make fine adjustments, clamping sleeve 94 includes—in an upper region—an outer thread 98 on its outer circumference, onto which an inner thread 100 of a stepped adjusting element 102—which is hollow-cylindrical in the lower section and is preferably made of plastic—is screwed. Inner thread 100 has preload relative to outer thread 98, to eliminate thread play. This may be brought about, e.g., by using a slightly larger or smaller thread pitch, or by using a slightly overlapping thread profile.

A long spring 104 is located inside main column 18. Long spring 104 is supported on base plate 24 and against adjusting element 102. Spring 104, which is designed as a compression spring, ensures that housing 10 is raised relative to base 10 plate 24 when clamping screw 96 is open, thereby enabling a milling tool inserted in motor spindle 48 to emerge from the work piece. Compression spring 104 is braced by adjusting element 102, with a disk 106 having a central projection 108 inserted between them. In the exemplary embodiment shown, projection 108 is designed as a ball inserted in disk 106. It rests in the center of the base of adjusting element 102. To this 15 end, adjusting element 102—which is otherwise preferably made of plastic—may be reinforced with, e.g., an intermediate metal ply. A mandrel 110 extends downward and away from disk 106 and into compression spring 104; it prevents compression spring 104 from collapsing.

A central neck 112 is located at the upper end of adjusting element 102. Housing upper piece 10a rests on shoulder 114, which is formed at the transition of the hollow-cylindrical piece to neck 112. A bearing 116 is inserted between shoulder 114 and neck 112. Housing upper piece 10a is connected with adjusting element 102 without play. An adjusting knob 118 is connected with neck 112.

The milling depth is changed by rotating adjusting knob 118. The resultant rotation of adjusting element 102 relative to clamping sleeve 94 fixedly connected with main column 18 and, therefore, base plate 24, results in housing 10—which is displaceably accommodated on guide columns 18, 20—being raised or lowered slightly, depending on the direction of rotation of adjusting knob 118.

As mentioned above, in order to adjust the milling depth, housing 10—which includes first stop 16, and from the underside of which tool fitting 12 for the milling tool extends—is accommodated on guide columns 18, 20 such that it is displaceable in the direction of vertical axis 30 of the router relative to base plate 24, which includes second stop 22, between a starting position 26 with stops 16, 22 with maximum separation, and end position 28, with stops 16, 22 lying one on top of the other, i.e., housing 10 is accommodated such that it is displaceable between a starting position 26 with stops 16, 22 with maximum separation, via intermediate positions to an end position 28 with stops 16, 22 lying one on top of the other, and in the reverse direction.

To simplify the handling of the router in particular, it is provided according to the present invention that a device 32 for displaying position 26, 28 of housing 10 is provided. To display position 26, 28 of housing 10, device 32 includes a pointer 36, which interacts with a scale 34. Pointer 36 is fixedly connected with one of the guide columns 20, and scale 34 is provided on housing 10. Scale 34 extends on housing 10 in the direction of vertical axis 30 of the router, i.e., scale 34 is mounted on housing 10, and a zero point 38 of scale 34 is located on an upper end 40 of scale 34. In end position 28 of housing 10, i.e., in the position in which stops 16, 22 lie on top of one another, pointer 36 is located at zero point 38 of scale 34. It is therefore possible to read the distance of housing 10 from end position 28, i.e., the “remaining displacement”, at any time.

It will be understood that each of the elements described above, or two or 10 more together, may also find a useful application in other types of constructions differing from the type described above.

While the invention has been illustrated and described as embodied in a router, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A router, comprising a base plate; a housing which is displaceably accommodated between a starting position and an end position for adjusting relative to said base plate; and a device for displaying a position of said housing.

2. A router as defined in claim 1, wherein said housing includes a first stop, while said base plate includes a second stop.

3. A router as defined in claim 2, wherein said housing is displaceable so that in said starting position said stops have a maximum separation and in said end position said stops lie one on top of the other.

4. A router as defined in claim 1; and further comprising guide columns, said housing being accommodated on said guide columns such that it is displaceable in a direction of a vertical axis of the router for adjusting a milling depth.

5. A router as defined in claim 1; and further comprising a tool fitting provided for a milling tool and extending out of an outer side of said housing.

6. A router as defined in claim 1, wherein said device for displaying the position of said housing includes a pointer that interacts with a scale.

7. A router as defined in claim 6; and further comprising guide columns on which said housing is accommodated, said pointer being fixedly connected with one of said guide columns and said scale being provided on said housing.

8. A router as defined in claim 6, wherein said housing is displaceable so that in said end position said pointer is located at a zero point on said scale.

9. A router as defined in claim 8, wherein said scale extends on said housing in a direction of a vertical axis of the router, while said zero point of said scale is located at a top end of said scale.

10. A router as defined in claim 1; and further comprising a device for roughly adjusting a milling depth.

11. A router as defined in claim 1; and further comprising a device for making fine adjustments of a milling depth.
